(19) United States
(12) Patent Application Publication
(10) Pub. No.: US 2017/0037903 A1
(43) Pub. Date: Feb. 9, 2017

(54) METHOD OF PURGING LUBRICANT WITHIN A BEARING AND SYSTEM USING THE METHOD

(71) Applicant: Paul Conley, St. Charles, MO (US)

(72) Inventor: Paul Conley, St. Charles, MO (US)

(21) Appl. No.: 15/304,711

(22) PCT Filed: Apr. 17, 2015
(86) PCT No.: PCT/US15/26496

§ 371 Date: Oct. 17, 2016

Related U.S. Application Data
(60) Provisional application No. 61/981,066, filed on Apr. 17, 2014.

(51) Int. Cl. F16C 33/66; F16C 19/06

(52) U.S. Cl. CPC F16C 33/6625; F16C 19/06; F16C 33/6607; F16C 2233/00

(57) ABSTRACT

A method of operating a lubrication system for lubricating a bearing in a housing includes the following steps: dispensing a quantity of lubricant within the bearing housing; monitoring a containment period of time during which the lubricant quantity is contained within the housing; determining when the containment time period exceeds a predetermined value of time; and dispensing another quantity of lubricant within the bearing housing when the containment time period exceeds the predetermined time value such that the other quantity of lubricant displaces the quantity of lubricant from the bearing housing.

### BACKGROUND OF THE INVENTION

The present invention relates to lubrication systems, particularly automatic lubrication systems for bearings.

Lubrication systems are known and typically contain a reservoir containing lubricant, one or more fluid supply lines for transporting the lubricant to a location to be lubricated, such as within a bearing, and a pump or other means to initiate flow from the reservoir, through the fluid lines and to the component to be lubricated. In certain systems, a valve controls flow from the supply line to the machine component and a controller is provided to operate the pump and open the valve(s).

In certain applications, one or more bearings that are lubricated by an automatic lubrication system may remain idle for prolonged periods of time. During such idle times, the lubricant, typically grease, remains at a particular volume or quantity, such that re-lubrication is not initiated. However, the grease may break-down due to exposure to elevated ambient temperatures or may become contaminated with liquids or solids, which could lead to adverse effects during the next operation of the machine component supported by the bearing. Specifically, grease tends to lose consistency, such that oil in the grease bleeds out, and/or oxidizes and breaks down, so as to be generally incapable of providing a film thickness.

### SUMMARY OF THE INVENTION

In one aspect, the present invention is a method of operating a lubrication system for lubricating a bearing in a housing. The method includes the following steps: dispensing a quantity of lubricant within the bearing housing; monitoring a containment period of time during which the lubricant quantity is contained within the housing; determining when the containment time period exceeds a predetermined value of time; and dispensing another quantity of lubricant within the bearing housing when the containment time period is about equal to or exceeds the predetermined time value such that the other quantity of lubricant displaces the quantity of lubricant from the bearing housing.

In another aspect, the present invention is also a system comprising a bearing having a housing, a lubricant reservoir, and a dispenser line fluidly coupled with the reservoir and having an outlet for dispensing lubricant within the bearing housing, and a pump for pumping lubricant from the reservoir and through the dispenser line. A control is configured to operate the pump to dispense a quantity of lubricant within the bearing housing, to monitor a period of time the lubricant quantity is contained within the housing, and to compare the lubricant containment period to a predetermined value of time. The control operates the pump to dispense another quantity of lubricant within the bearing housing when the lubricant containment period is about equal to or exceeds the predetermined time value such that the other quantity of lubricant displaces the quantity of lubricant from the housing.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a schematic view of a first construction of a lubrication system in accordance with the present invention;

FIG. 2 is a schematic view of a second construction of a lubrication system in accordance with the present invention;

FIG. 3 is a broken-away, enlarged view of a portion of FIG. 2;

FIG. 4 is a flow diagram depicting a control process for operating a pump and dispenser valves to dispense lubricant within a bearing housing;

FIG. 5 is a cross-sectional view of a bearing lubricated and purged by the present lubrication system; and

FIG. 6 is a partly-broken away, cross-sectional view through a dispenser valve, an injector and a manifold.

### DETAILED DESCRIPTION OF THE INVENTION

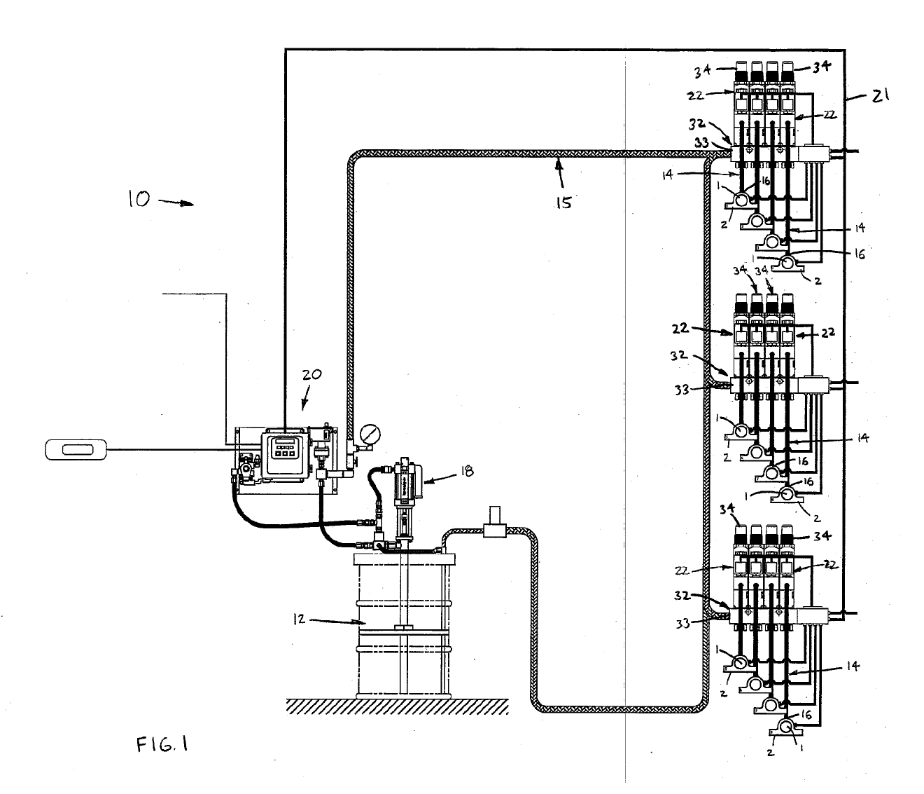

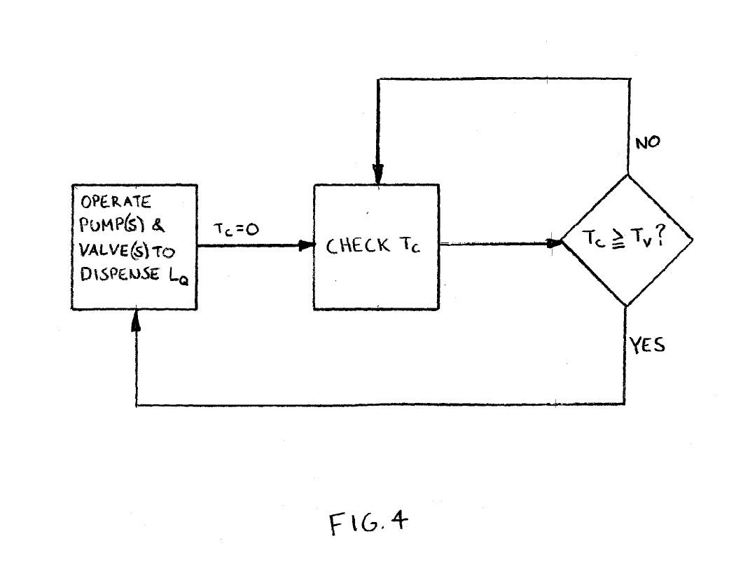

Referring now to the drawings in detail, wherein like numbers are used to indicate like elements throughout, there is shown in FIGS. 1-6 a lubrication system 10 for lubricating one or more bearings 1 each disposed within a housing 2. The lubrication system 10 basically comprises a lubricant reservoir 12 containing lubricant, preferably grease, one or more dispenser lines 14, a pump 18 and a control 20. Each dispenser line 14 is fluidly coupled with the reservoir 12, preferably through a supply line 15 extending between the pump 18 and the dispenser line 14, and has an outlet 16 for dispensing lubricant within or into a bearing housing 2. The pump 18 is configured to pump lubricant from the reservoir 12, through the supply line 15, and through each dispenser line 14. The control 20 is configured to operate the pump 18 to dispense a quantity of lubricant L_{Q} within each bearing housing 2, to monitor a period of time T_{C} the lubricant quantity L_{Q} is disposed or contained within the housing 2 and to compare the lubricant containment period T_{C} to a predetermined value of time T_{V}, which corresponds to an effective “life” of the lubricant quantity L_{Q}, as indicated in FIG. 4.

Further, the control 20 is also configured to operate the pump 18 to dispense another, “fresh” quantity of lubricant L_{Q} within each bearing housing 2 when the lubricant containment period T_{C} is about equal to or exceeds the predetermined time value T_{V} (i.e., T_{C}≧T_{V}), such that the other quantity of lubricant L_{Q} displaces the older, “degraded” quantity of lubricant L_{Q} from the housing 2. Thus, lubricant that has been dormant within the bearing(s) 1 for a period of time is “flushed” out of each bearing 1 so as to avoid potential issues such as grease breakdown, water or solid contaminants within the grease, etc.

Furthermore, the predetermined time value T_{V} may be a predetermined constant value stored within electronic memory of the control 20 or the control 20 may be configured to determine the predetermined time value T_{V} based upon an estimated period of lubricant effectiveness, which may be adjusted or based upon information from sensors (none shown) providing information on specific bearing operating conditions (e.g., bearing rotational speed, bearing temperature, lubricant temperature, etc.). Specifically, the control 20 may be configured to determine or calculate the predetermined time value lubricant effectiveness period P_{E} using both information from one or more sensors and empirically-derived data stored within memory of the control 20. Such empirical data may be generated by measuring the time period between the point in time at which a quantity of “fresh” (i.e., unused) lubricant is provided or delivered into the bearing housing 2 until the point in time at which the particular quantity of lubricant has degraded to the extent of being generally ineffective to lubricate, or at least the lubrication effectiveness has diminished significantly, as discussed above. The data is preferably generated for each one of a plurality of different sets or combinations of operating conditions, such as different bearing and/or lubricant temperatures, different bearing speeds, etc., and for any other relevant variable operating condition or parameter, and the data is stored within the control 26.

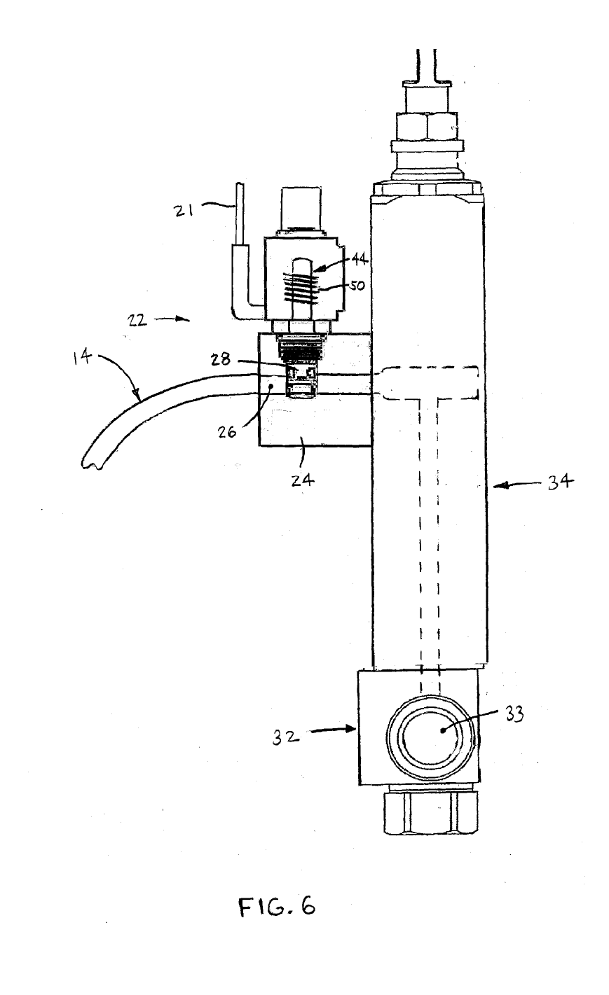

Preferably, the lubrication system 10 further comprises one or more dispenser valves 22 for permitting flow through an associated dispenser line 14, each of which is preferably a normally closed, solenoid operated valve. As such, the control 20 is configured to open each valve 22 to dispense each quantity of lubricant L_{Q} into the associated bearing housing 2, i.e., the initial quantity of lubricant L_{Q} and each subsequent or “other” quantity of lubricant L_{Q} dispensed thereafter. As best shown in FIG. 6, each dispenser valve 22 includes a valve body 24 with an internal passage 26 fluidly coupling the lubricant reservoir 12, preferably through the lubricant supply line 15, to the dispenser line 14, and a movable closure element 28 at least partially disposed within the body 24. The closure element 28 is movable between a closed position at which lubricant flow through the valve passage 26 is obstructed and an open position at which lubricant flow through the valve passage 26 is permitted. Preferably, a solenoid 30 is connected with the closure element 28 and is operatively connected with the control 20, preferably through a bus line 21, such that the control 20 initiates displacement of the closure element 28 from the closed position to the open position. Although preferably formed as a normally-closed, solenoid actuated valve, the one or more dispenser valves 22 may be constructed as any other appropriate type of valve, such as for example, a rotatable ball valve, a motor-driven stem valve, etc., and the scope of the present invention is in no manner limited to any particular structure of the valve 22.

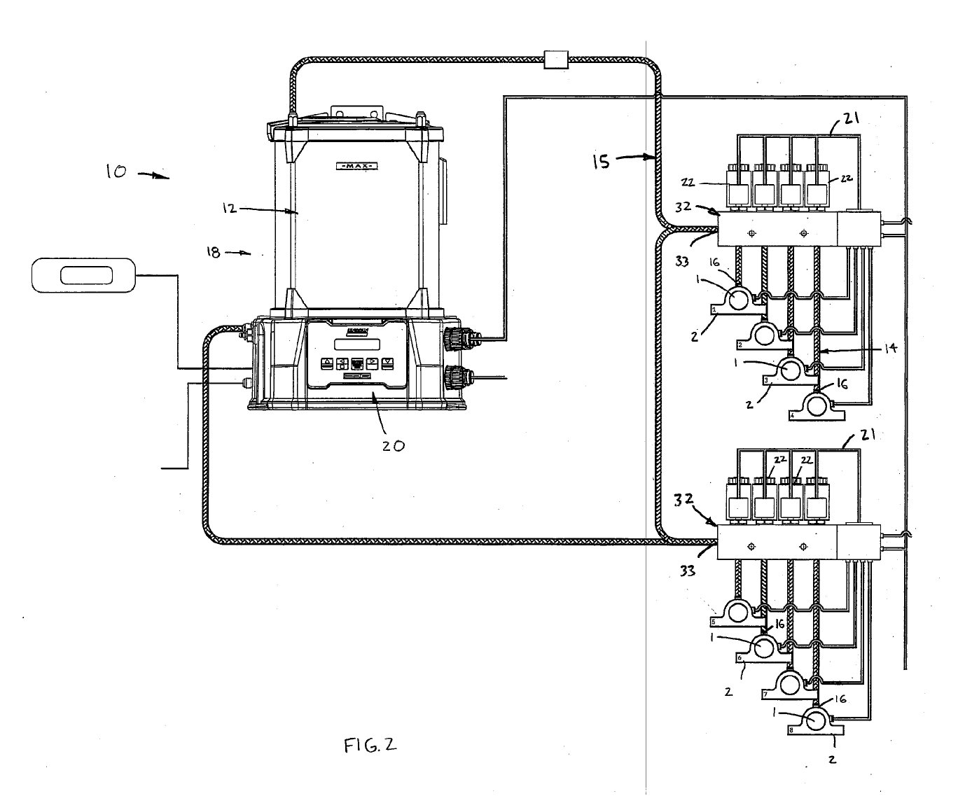

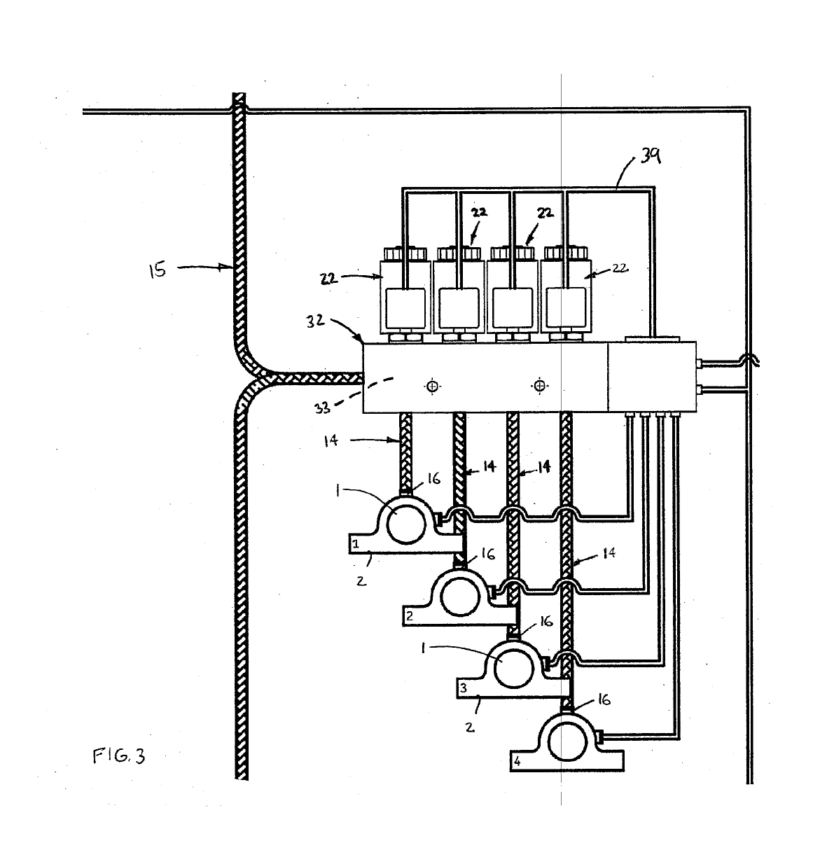

Further, each dispenser valve 22 is preferably connected with a manifold 32, either directly as shown in FIGS. 2 and 3 or through an injector 34, as shown in FIGS. 1 and 6. In either case, each manifold 32 has a central passage 33 which fluidly connects the supply line 15 to the valve passage 26 of one or more dispenser valves 22, and thus fluidly connects the pump 18 with one or more dispenser lines 14. In certain constructions, as shown in FIGS. 1 and 6, an injector 34 is provided for each dispensing valve 22 so as to provide a predetermined quantity of lubricant to the associated dispenser valve 22. Preferably, each injector 34 is formed as generally disclosed in U.S. Pat. Nos. 6,705,432 and 6,810,998, the entire contents of each patent being incorporated by reference herein.

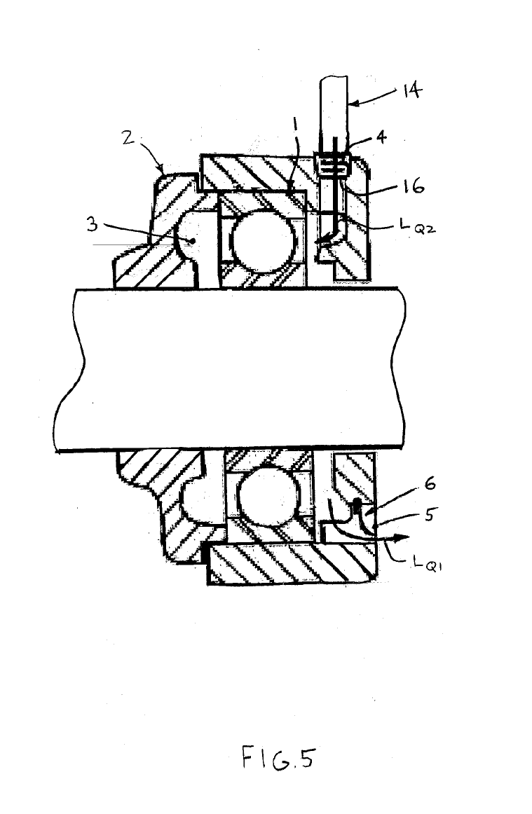

As best shown in FIG. 5, each bearing housing 2 has an interior chamber 3 for retaining lubricant, an inlet 4 fluidly connected with the associated dispenser line 14, an outlet 5 for egress or evacuation of used lubricant, and at least one seal 6 for retaining lubricant within the bearing chamber 3. The seal 6 is deflectable under fluid pressure to permit the older or “degraded” quantity of lubricant, indicated as L_{Q1} in FIG. 5, to flow out of the bearing housing chamber 3 and through the outlet 5 when the other, “fresh” quantity of lubricant, indicated as L_{Q2}, is dispensed within or into the bearing 1. The housing outlet 5 is preferably fluidly connected with a lubricant reclamation tank or other vessel (not shown) for storing the used lubricant by appropriate means.

As described above and depicted in FIG. 4, a method of operating a lubrication system 10, for lubricating a bearing 1 disposed within a housing 2, basically comprises the following steps:
dispensing a quantity of lubricant L_{Q} within the bearing housing 2;
monitoring a containment period of time T_{C} during which the lubricant quantity is disposed within the housing 2;
determining when the lubricant containment period T_{C} exceeds a predetermined value of time T_{V}; and
dispensing another, “fresh” quantity of lubricant L_{Q} within the bearing housing 2 when the containment time period T_{C} is about equal to or exceeds the predetermined time value T_{V} such that the other quantity of lubricant L_{Q} displaces the “used” or/and “degraded” quantity of lubricant L_{Q} to flow out the housing 2.

The steps of dispensing the quantity of lubricant and dispensing another quantity of lubricant each includes operating the pump 18 and opening one or more dispenser valves 22 to dispense each quantity of lubricant L_{Q} into the bearing 1 or bearing housing 2. The dispenser valves 22 may each be opened (i.e., by command of the control 20) for a predetermined period of time, for a number of lubrication cycles, or to receive a specified amount of lubricant from the pump or an injector (not shown). The control 20 performs the steps of monitoring the disposal time period and determining when the containment time period T_{C} is about equal to or exceeds the predetermined time value T_{V}, and also operates the pump 18 and the valves 22 to dispense the lubricant. Further, the process of monitoring the lubricant containment period T_{C} and dispensing additional, fresh quantities of lubricant L_{Q} is continuously repeated as long as the lubrication system 10 is functioning.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined herein and in the appended claims.

I claim:

1. A method of operating a lubrication system for lubricating a bearing in a housing, the lubrication system including a lubricant reservoir and a dispenser line fluidly coupled with the reservoir and having an outlet for dispensing lubricant within the bearing housing, the method comprising the steps of:
dispensing a quantity of lubricant within the bearing housing;
monitoring a containment period of time during which the lubricant quantity is contained within the housing;
determining when the containment time period exceeds a predetermined value of time; and
dispensing another quantity of lubricant within the bearing housing when the containment time period is about equal to or exceeds the predetermined time value such that the other quantity of lubricant displaces the quantity of lubricant from the bearing housing.

2. The method as recited in claim 1 wherein the lubrication system includes a pump for pumping lubricant from the reservoir to the dispenser line, the step of dispensing the quantity of lubricant includes operating the pump and the step of dispensing another quantity of lubricant includes operating the pump.

3. The method as recited in claim 1 wherein the lubrication system includes a dispenser valve controlling flow through the dispenser line, the step of dispensing the quantity of lubricant includes opening the dispenser valve to dispense the quantity of lubricant, and the step of dispensing another quantity of lubricant includes opening the dispenser valve to dispense the other quantity of lubricant.

4. The method as recited in claim 1 wherein the lubrication system includes a control configured to monitor the containment time period and to determine when the containment time period exceeds the predetermined time value.

5. A system comprising:
a bearing having a housing;
a lubricant reservoir;
a dispenser line fluidly coupled with the reservoir and having an outlet for dispensing lubricant within the bearing housing;
a pump for pumping lubricant from the reservoir and through the dispenser line; and
a control configured to operate the pump to dispense a quantity of lubricant within the bearing housing, to monitor a period of time the lubricant quantity is contained within the housing, to compare the lubricant containment period to a predetermined value of time, and to operate the pump to dispense another quantity of lubricant within the bearing housing when the lubricant containment period exceeds the predetermined time value such that the other quantity of lubricant displaces the quantity of lubricant from the housing.

6. The system as recited in claim 5 further comprising a dispenser valve for permitting flow through the dispenser line, the control being configured to open the valve to dispense the quantity of lubricant and to open the valve to dispense the other quantity of lubricant.

7. The system as recited in claim 6 wherein the dispenser valve is a normally closed valve.

8. The system as recited in claim 5 wherein the bearing has an interior chamber for retaining lubricant and at least one seal for retaining lubricant within the bearing chamber, the seal being deflectable to permit the quantity of lubricant to flow out of the bearing chamber when the other quantity of lubricant is dispensed within the bearing.

9. The system as recited in claim 8 wherein the bearing housing has at least one opening for permitting the displaced quantity of lubricant to flow out of the housing.
